(19) United States
(12) Patent Application Publication
(10) Pub. No.: US 2026/0250069 A1
(43) Pub. Date: Aug. 27, 2026

(54) AN AUTOMATED STORAGE AND RETRIEVAL SYSTEM HAVING A CONTAINER TRANSFER SYSTEM AND A METHOD THEREOF

(71) Applicant: AutoStore Technology AS, Nedre Vats (NO)

(72) Inventors: Trond Austrheim, Etne (NO); Ole Andreas Haddeland, Avaldsnes (NO)

(21) Appl. No.: 18/874,870

(22) PCT Filed: Aug. 11, 2023
(86) PCT No.: PCT/EP2023/072341

§ 371 Date: Dec. 13, 2024

(30) Foreign Application Priority Data
Aug. 12, 2022 (NO) 20220876

(51) Int. Cl. B65G 1/04; F25D 13/04

(52) U.S. Cl. CPC B65G 1/0464; F25D 13/04; B65G 2203/0283

(57) ABSTRACT

The invention concerns an automated storage and retrieval system and a method using the system. The system comprises a wall separating the storage system in a first space and a second space, a tunnel extending through the wall and a partition vehicle movably arranged within the tunnel. The tunnel may be configured to allow transport of storage containers between the first space and the second space.

### TECHNICAL FILD

The present invention relates to an automated storage and retrieval system, a container transfer system using such a system and a method for transport of storage containers via the container transfer system.

### BACKGROUND AND PRIOR ART

FIG. 1 discloses a prior art automated storage and retrieval system 1 with a framework structure 100 and FIGS. 2, 3 and 4 disclose three different prior art container handling devices 200,300,400 suitable for operating on such a system 1.

The framework structure 100 comprises upright members 102 and a storage volume 104 comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of the storage volume 104, on which rail system 108 a plurality of container handling devices 200,300,400 may be operated to raise bins 106 from, and lower bins 106 into, the storage columns 105, and also to transport the bins 106 above the storage columns 105. The rail system 108 comprises a first set of parallel rails 110 arranged to guide movement of the container handling devices 200,300,400 in a first direction X across the top of the frame structure 100, and a second set of parallel rails 111 arranged perpendicular to the first set of rails 110 to guide movement of the container handling devices 200,300,400 in a second direction Y which is perpendicular to the first direction X. Containers 106 stored in the columns 105 are accessed by the container handling devices 200,300,400 through access openings 112 in the rail system 108. The container handling devices 200,300,400 can move laterally above the storage columns 105, i.e. in a plane which is parallel to the horizontal X-Y plane.

The upright members 102 of the framework structure 100 may be used to guide the bins 106 during raising of the bins 106 out from and lowering of the bins 106 into the columns 105. The stacks 107 of bins 106 are typically self-supporting.

Each prior art container handling device 200,300,400 comprises a handling device body/vehicle body 201,301,401 and first and second sets of wheels 202a,202b,302a,302b,402a,402b which enable the lateral movement of the container handling devices 200,300,400 in the X direction and in the Y direction, respectively. In FIGS. 2, 3 and 4 two wheels in each set are fully visible. The first set of wheels 202a,302a,402a is arranged to engage with two adjacent rails of the first set 110 of rails, and the second set of wheels 202b,302b,402b is arranged to engage with two adjacent rails of the second set 111 of rails. At least one of the sets of wheels 202a, 202b, 302a,302b,402a,402b can be lifted and lowered, so that the first set of wheels 202a,302a,402a and/or the second set of wheels 202b,302b,402b can be engaged with the respective set of rails 110, 111 at any one time.

Each prior art container handling device 200,300,400 also comprises a lifting device 303,403 for vertical transportation of bins 106, e.g. raising a bin 106 from, and lowering a bin 106 into, a storage column 105. The lifting device 303,403 comprises one or more gripping/engaging devices 404 which are adapted to engage a bin 106, and which gripping/engaging devices 404 can be lowered from the vehicle 200,300,400 so that the position of the gripping/engaging devices 404 with respect to the vehicle 200,300,400 can be adjusted in a third direction Z which is orthogonal the first direction X and the second direction Y. The gripping device 404 of the container handling device/vehicle 400 in form of a plurality of claws is shown in FIG. 4. The lifting device of the container handling device 200 is located within the vehicle body 201 and is thus not shown.

Conventionally, and also for the purpose of this application, Z=1 identifies the uppermost layer available for bins below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of bins. Similarly, X=1 . . . n and Y=1 n identifies the position of each storage column 105 in the horizontal plane. Consequently, as an example, and using the Cartesian coordinate system X, Y, Z indicated in FIG. 1, the bins identified as 106′ in FIG. 1 can be said to occupy storage position X=17, Y=1, Z=6. The container handling devices 200,300,400 can be said to travel in layer Z=0, and each storage column 105 can be identified by its X and Y coordinates. Thus, the bins shown in FIG. 1 extending above the rail system 108 are also said to be arranged in layer Z=0.

The storage volume of the framework structure 100 has often been referred to as a grid, where the possible storage positions within this grid are referred to as storage cells. Each storage column may be identified by a position in an X-and Y-direction, while each storage cell may be identified by a container number in the X-, Y-and Z-direction.

Each prior art container handling device 200,300,400 comprises a storage compartment or space for receiving and stowing a bin 106 when transporting the bin 106 across the rail system 108. The storage space may comprise a cavity arranged internally within the vehicle body 201,301,401 as present in FIGS. 2 and 4 and as described in e.g. WO2015/15,193,278A1 and WO2019/206487A1, the contents of which are incorporated herein by reference.

FIG. 3 shows an alternative configuration of a container handling device/vehicle 300 with a cantilever construction. Such a vehicle is described in detail in e.g. NO317366, the contents of which are also incorporated herein by reference.

The central cavity type vehicle 200 shown in FIG. 2 may have a footprint that covers an area with dimensions in the X and Y directions which is generally equal to the lateral extent of a storage column 105, e.g. as is described in WO 2015/193278A1, the contents of which are incorporated herein by reference. The term ‘lateral’ used herein may mean ‘horizontal’.

Alternatively, the cavity container handling devices/vehicle 400 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where bins 106 are stored in stacks 107. However, some columns 105 may have other purposes. In FIG. 1, columns 119 and 120 are such special-purpose columns used by the container handling devices 200,300,400 to drop off and/or pick up bins 106 so that they can be transported to an access station (not shown) where the bins 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the bins 106 may be placed in a random or dedicated column 105 within the framework structure 100, then picked up by any container handling device and transported to a port column 119,120 for further transportation to an access station. The transportation from the port to the access station may require movement along various different directions, by means such as delivery vehicles, trolleys or other transportation lines. Note that the term ‘tilted’ means transportation of bins 106 having a general transportation orientation somewhere between horizontal and vertical.

In FIG. 1, the first port column 119 may for example be a dedicated drop-off port column where the container handling devices 200,300,400 can drop off bins 106 to be transported to an access or a transfer station, and the second port column 120 may be a dedicated pick-up port column where the container handling devices 200,300,400 can pick up bins 106 that have been transported from an access or a transfer station. The access station may typically be a picking or a stocking station where product items are removed from or positioned into the bins 106. In a picking or a stocking station, the bins 106 are normally not removed from the automated storage and retrieval system 1, but are returned into the framework structure 100 again once accessed. A port can also be used for transferring bins to another storage facility (e.g. to another framework structure or to another automated storage and retrieval system), to a transport vehicle (e.g. a train or a lorry), or to a production facility.

A conveyor system comprising conveyors is normally employed to transport the bins between the port columns 119,120 and the access station.

If the port columns 119,120 and the access station are located at different levels, the conveyor system may comprise a lift device with a vertical component for transporting the bins 106 vertically between the port column 119,120 and the access station.

The conveyor system may be arranged to transfer bins 106 between different framework structures, e.g. as is described in WO2014/075937A1, the contents of which are incorporated herein by reference.

When a bin 106 stored in one of the columns 105 disclosed in FIG. 1 is to be accessed, one of the container handling devices 200,300,400 is instructed to retrieve the target bin 106 from its position and transport it to the drop-off port column 119. This operation involves moving the container handling device 200,300,400 to a location above the storage column 105 in which the target bin 106 is positioned, retrieving the bin 106 from the storage column 105 using the container handling device's 200,300,400 lifting device, and transporting the bin 106 to the drop-off port column 119. If the target bin 106 is located deep within a stack 107, i.e. with one or a plurality of other bins 106 positioned above the target bin 106, the operation also involves temporarily moving the above-positioned bins prior to lifting the target bin 106 from the storage column 105. This step, which is sometimes referred to as “digging” within the art, may be performed with the same container handling device that is subsequently used for transporting the target bin to the drop-off port column 119, or with one or a plurality of other cooperating container handling devices. Alternatively, or in addition, the automated storage and retrieval system 1 may have container handling devices 200,300,400 specifically dedicated to the task of temporarily removing bins 106 from a storage column 105. Once the target bin 106 has been removed from the storage column 105, the temporarily removed bins 106 can be repositioned into the original storage column 105. However, the removed bins 106 may alternatively be relocated to other storage columns 105.

When a bin 106 is to be stored in one of the columns 105, one of the container handling devices 200,300,400 is instructed to pick up the bin 106 from the pick-up port column 120 and transport it to a location above the storage column 105 where it is to be stored. After any bins 106 positioned at or above the target position within the stack 107 have been removed, the container handling device 200,300,400 positions the bin 106 at the desired position. The removed bins 106 may then be lowered back into the storage column 105, or relocated to other storage columns 105. For monitoring and controlling the automated storage and retrieval system 1, e.g. monitoring and controlling the location of respective bins 106 within the framework structure 100, the content of each bin 106; and the movement of the container handling devices 200,300,400 so that a desired bin 106 can be delivered to the desired location at the desired time without the container handling devices 200,300,400 colliding with each other, the automated storage and retrieval system 1 comprises a control system 700 which typically is computerized and which typically comprises a database for keeping track of the bins 106.

Automated storage and retrieval systems as described above are typically constructed to be operated in areas at ambient temperatures, e.g. about 20° C. However, for some type of products optimal storage temperature may be different. For example, it may be desirable to store food at fridge temperature, typically between 1-4° C., or at freezer temperature, typically below −18° C. or below −20° C.

Furthermore, there may be situations to surround an automated storage and retrieval system with an atmosphere different from the ambient atmosphere, for example to reduce the risk of fire ignition by reducing the oxygen concentration in the surrounding atmosphere.

Automatic storage and retrieval systems having different temperature zones, and where the temperature can be controlled, are known. For example, patent publication WO 2015/124610 A1 describes a system for receiving and storing processed refrigerated and frozen food products using a plurality of container handling vehicles operated on a rail system. In this prior art solution, the bins are stacked below a common rail system in two different storage volumes separated by a wall. The container handling vehicles are allowed to freely move above the two storage volumes at an operating temperature such as room-temperature.

One disadvantage of this prior art solution is that a container handling vehicle is exposed for colder temperature when a bin at the colder zone is stored or retrieved. This may result in formation of condense, causing disturbances with electronics.

The prior art storage system described in WO 2019/001816 A1 shows a system with different temperature zones and means for transporting containers between the different temperature zones. In order to reduce temporary exposure of cold air onto the container handling vehicles, the solution comprises an elevator allowing lowering and raising of bins between an access point to a transfer zone.

However, this solution is complex and costly.

A storage facility where the oxygen concentration may be reduced in order to prevent start of fire is described in the article “WagnerImpulse” in the magazine “The Wagner Group Customer magazine” (3/2018). The low oxygen concentration is obtained by forcing oxygen-reduced air into the entire storage facility.

The article does not present any solutions for maintaining such a low oxygen concentration over a long time-span such as several days. For example, the article gives no indication of how the storage system may be operated to transport bins in or out of the storage system without increasing the oxygen concentration. Such an operation would necessitate frequent exposure of the storage system to atmospheric air.

It is an aim of the present invention to provide an automated storage and retrieval system and a method for operating such a system that solves or at least mitigates one or more of the aforementioned problems related to the use of prior art storage and retrieval systems. It is also an aim of the present invention to provide solutions that allows handling of bins within a storage system located in a space having an environment different than the surrounding environment.

It is also an aim of the present invention to provide an an automated storage and retrieval system which may allow storage of products for which the optimal storage temperatures may deviate from ambient temperature.

### SUMMARY OF THE INVENTION

The present invention is set forth and characterized in the independent claims, while the dependent claims describe other preferred/optional features.

In a first aspect, the invention concerns an automated storage and retrieval system comprising a wall separating the storage system into at least a first space and a second space, a tunnel extending through the wall and a partition vehicle arranged within the tunnel.

The storage and retrieval system may comprise a first storage volume allowing storage of storage containers in vertical stacks, the storage volume including a rail system arranged above where the vertical stacks of storage containers would be stored; a container transfer space extending from a side of, or arranged adjacent to, the first storage volume and configured to hold at least one of the storage containers, a first container handling vehicle configured to lift a storage container from the first storage volume by use of a lifting device and to transport the storage container along the rail system to the container transfer space and a container transporting device (such as a multi-joint robot arm and/or a second container handling vehicle) configured to lift the storage container from the container transfer space and to transport the storage container to another location more distant from the first space. The transport of the storage containers along the rail system may be achieved by equipping the first container handling vehicle with suitable rolling means, such as wheels which engage rails of the rail system.

The first storage volume may contain a plurality of vertical upright members defining a plurality of storage columns for storing the stacks of storage containers.

The rail system comprises a first set of rails and a second set of rails oriented perpendicular to the first set of rails, the intersections of which rails form a grid of grid cells defining grid openings that allow the first container handling vehicle to lift the storage containers therethrough. The rail system may continue into the second space.

The container transfer space may have a horizontal extent corresponding to a specific number of grid cells, for example, extending two grid cells in a direction parallel to the wall and one grid cell perpendicular to the wall. The container transfer space may be located along the middle of the tunnel, for example, in a space of two grid cells in a direction parallel to the wall and three grid cells perpendicular to the wall.

The tunnel extending through the wall is at a level of the rail system and may be configured to allow transport of storage containers between the first space and the second space.

The partition vehicle is configured to move at least between a first position within the first space and a second position within the second space. The first and second positions may be a first partition position and a second partition position relative to the wall, wherein the partition positions are located within the tunnel.

The purpose of the partition vehicle is to provide a partition between the first space and the second space that can be moved between the first position and the second position across the container transfer space. In this way, the partition vehicle provides a partition that is moveable within the tunnel which is located in the wall.

The inner cross sectional area of the tunnel perpendicular to the rail system should consequently be equal or larger than the corresponding cross sectional area of the partition vehicle. A block-off between the first and second space is best achieved when the two areas are equal or approximately equal. Furthermore, the inner cross sectional area should be larger than storage container to be transported.

To avoid or reduce and gas exchange and/or temperature equalization between the first and second space, or to avoid or reduce contamination of the first space, the cross sectional area of the partition vehicle is preferably equal or approximately equal to the inner cross sectional area of the tunnel. For example, if the width of the tunnel extends across two grid cells, the partition vehicle can be made two grid cells wide. The height of the partition vehicle may extend to block off, or at least substantially block off (e.g., 90% of the area or more), the inner cross sectional area of the tunnel. The partition vehicle may be arranged to expand in area upon reaching the first or second positions to block off the tunnel more effectively.

The automated storage and retrieval system may also be designed such that the partition vehicle may move beyond the extent of the tunnel at times, for example a distance into the first space that allows the first container handling vehicle to move through the tunnel into the second space, e.g., at times when the first container vehicle is in need of service or repair.

Alternatively, or in addition, the automated storage and retrieval system may be designed such that the partition vehicle may move into the second space to allow any second container handling vehicles to move through the tunnel into the first space.

Hence, the partition vehicle is constructed so that it may reciprocate back and forth in the direction of movement of the storage container as it is being transferred from the first space to the second space, i.e. in the longitudinal direction of the tunnel, while at the same time is able to maintain blocking off, or at least substantially blocking off, a transverse area. The partition vehicle is thereby able to separate the first space from the second space in at least one of the positions above the container transfer space, and preferably whilst it is reciprocating between the first and second partition spaces.

In an exemplary configuration, the first space is enclosed in order to avoid surrounding fluid, such as gas, to enter in an uncontrolled manner. Hence, such enclosure should not be construed as a fully gas isolating space, but rather construed as sufficiently enclosed to fulfil the particular purpose of the automated storage and retrieval system, for example, to avoid significant temperature variations between the first and second space and/or to avoid significant gas leakage between the first and second space. The enclosure enclosing the first space may thus include various openings/venting systems, such as gas inlets with valves, to control the first space of surrounding fluid in a controlled manner, for example, in order to create a more inert atmosphere and/or to set the temperature of the first space to a temperature different from the surrounding temperature.

The term ‘enclosed first space’ is herein defined as a space being separated from the surroundings by wall(s). For example, if the first space is formed as a cuboid, the term ‘enclosing’ means six walls separating the space from the surroundings, the term “walls” including a floor and a ceiling.

In another exemplary configuration, the container transporting device is a second container handling vehicle configured to transport a storage container from the container transfer space along the rail system. The second container handling vehicle and the first container handling vehicle may have identical designs.

In yet another exemplary configuration, the storage and retrieval system may comprise a second storage volume contained within the second space, allowing storage of storage containers in vertical stacks. The container transfer space is in this configuration arranged between the first storage volume and the second storage volume. The rail system may extend above the second storage volume.

In yet another exemplary configuration, the container transfer space is arranged below the rail system.

In yet another exemplary configuration, the container transfer space is positioned such that a center plane of the wall intersects a centre of the container transfer space.

In yet another exemplary configuration, the container transfer space is configured to hold a plurality of storage containers at the same time, for example, distributed horizontally at the same height or generally the same height as a top level of storage containers within the first storage volume (e.g., a Z=1 level, a Z=2 level or somewhere between the two) and/or could be stored in one or more vertical stacks of two or more storage containers. In case of the latter, the container transfer space may include vertical upright members defining at least one storage column in which the stacks of storage containers may be contained.

In yet another exemplary configuration, the automated storage and retrieval system comprises a cooling unit configured to provide a cooler temperature within the first space than the temperature within the second space. Furthermore, the wall may be provided with thermal insulation, such as expanded polystyrene or a similar foam material, to reduce thermal conductivity between the first and second spaces.

The cooling unit may be an air-conditioning system to allow a compressed cooling chemical to evaporate from liquid to gas while absorbing heat in the process.

Alternatively, or in addition, the cooling unit may be a refrigeration unit having a heat pump that transfers heat from within the first space to an outside space.

Herein, air-conditioning system and refrigeration unit are defined broadly covering a large temperature range, for example between a temperature below −20° C. and an ambient temperature (20° C.-25° C., for example 23° C.), or between −20° C. and an ambient temperature, or between −5° C. and an ambient temperature.

In yet another exemplary configuration, the first space may be set at a gas pressure different than the gas pressure within the second space, for example to reduce the risk of gas leakage.

In yet another exemplary configuration, the first space may be filled with a gas different than the gas within the second space such as a gas being less flammable than air to reduce the risk of fire.

In yet another exemplary configuration, the partition vehicle may comprise drive means to drive the partition vehicle between the first and second positions.

Furthermore, the movements of the partition vehicle are preferably achieved by use of a remote control system in signal communication with a controller arranged on a vertical extending structure/vertical plate of the vehicle. The partition vehicle may also comprise a sensor configured to register a position of the partition vehicle relative to the tunnel, wherein the sensor is in signal communication with the drive means, either directly or via the remote control system. The tunnel could also carry such sensor(s).

In yet another exemplary configuration, the partition vehicle comprises wheels configured to move along the first set of rails. In such configuration the wheels should be designed to provide the requisite stability for the partition vehicle while also avoid hinderance for co-operating first container handling vehicles and container transporting device. Alternatively, or in addition, the partition vehicle may be suspended from the roof of the tunnel and/or supported on rails at the sides of the tunnel.

The wheels may comprises a first set of wheels (e.g., a pair of wheels) at one side of the partition vehicle and a second set of wheels (e.g., a second pair of wheels) at a second opposite side of the partition vehicle (looking at the partition vehicle along the longitudinal direction of the tunnel), wherein the first and second sets of wheels are offset by at least one grid opening (i.e., rail to rail separation of a grid cell). Furthermore, the wheels are adapted to move along the first set of rails.

In yet another exemplary configuration, a partition width of the partition vehicle equals n times the width of the grid cell, wherein n is a positive integer. A typical value of n is 2 or 3.

In yet another exemplary configuration, the partition vehicle comprises a member such as a plate oriented in parallel with a center plane of the wall and a seal surrounding at least partly an edge of the member/plate. The seal may contact inside walls of the tunnel and the rail system when the partition vehicle is moving between the first position and the second position, thereby ensuring that the partition vehicle creates a sealing fit with the inside of the tunnel. The seal is also present when the partition vehicle is at the first and second positions.

For example, if the plate has a rectangular cross section, the seal should preferably cover at least the vertical edges and the top horizontal edge.

The desired seals against the tunnel walls may be achieved by various means such as brush seals, flaps, rolling seals and/or air seals.

Seals, for example brush seals, flaps, rolling seal and/or air seals, could be provided on the inner surfaces of the tunnel, either in place of, or in addition to seals on the partition vehicle.

In yet another exemplary configuration, the partition vehicle comprises a battery configured to provide power to the drive means. The battery is rechargeable.

In yet another exemplary configuration, the partition vehicle is provided with thermal insulation, such as expanded polystyrene or a similar foam material, to reduce thermal conductivity between the first space and the second space through the tunnel. Such insulation may be configured for the particular design of the partition vehicle, for example by providing insulation between the wheels.

In yet another exemplary configuration, wherein the automated storage and retrieval system comprises a floor extending along the rail system, e.g., across at least an opening of the tunnel, for example, at the first position and/or the second position.

The floor may comprise a plurality of floor plates, each having length and width corresponding to the grid opening of the rail system.

Furthermore, the floor may be provided with thermal insulation to reduce thermal conductivity between the first space and the second space through the container transfer space.

In a second aspect, the invention concerns a container transfer system for transfer of storage containers between a first space of the automated storage and retrieval system having a first temperature and a second space of the automated storage and retrieval system having a second temperature higher than the first temperature.

The container transfer system comprises a wall separates the automated storage and retrieval system into the first space and the second space, a tunnel extending through the wall, wherein the tunnel is configured to allow transport of storage containers between the first space and the second space and a partition vehicle arranged within the tunnel.

The partition vehicle is preferably provided with thermal insulation to reduce thermal conductivity between the first space and the second space through the tunnel.

Furthermore, the partition vehicle comprises drive means to allow movement of the partition vehicle along the tunnel, for example, four wheels motorized with one or more external motors or one or more in wheel motors.

The partition vehicle preferably extends across the transverse direction of the tunnel. For example, the partition vehicle may be tight-fittingly arranged, i.e. where a maximum cross-sectional area of the vehicle is equal to, or slightly less than, a minimum cross-sectional area of the tunnel.

In an exemplary configuration, the partition vehicle comprises a member/wall section and a seal surrounding an edge of the member. The seal may contact inside walls of the tunnel when the partition vehicle is moving along the tunnel.

In another exemplary configuration, the partition vehicle comprises a sensor configured to register a position of the partition vehicle relative to the tunnel. The sensor may be in signal communication with the drive means of the partition vehicle, either directly or via a remote control system.

In a third aspect, the invention concerns a partition vehicle arrangeable within a tunnel, wherein the partition vehicle is provided with thermal insulation to reduce thermal conductivity between a first space and a second space located on opposite sides of the tunnel and wherein the partition vehicle comprises drive means, such as belt and/or shaft driven wheels, or two or four in motor wheels to allow movement of the partition vehicle along the tunnel. If a vehicle body of the partition vehicle has a rectangular design, the partition vehicle may comprise four wheels which may be placed at or near the vehicle body's lower corners. The wheels allow the partition vehicle to move in the X-direction. The motor driving the wheels may be a DC motor. The partition vehicle may comprise a vertical extending structure/wall member/upright partition and a seal surrounding an edge of the wall member, wherein the seal is contacting inside walls of the tunnel when the partition vehicle is moving along the tunnel. Furthermore, the partition vehicle may be configured in accordance with any of the features as described above concerning the first or the second aspects of the invention. The wheels may be placed at or near the corners of the vertical extending structure.

In a fourth aspect, the invention concerns an assembly of a tunnel and a partition vehicle that can be fitted into a hole in a wall separating a first space from a second space. The tunnel and partition vehicle may comprise any of the features as described above concerning the first, the second and/or the third aspects of the invention.

In a fifth aspect, the invention concerns a partition vehicle which may comprise any of the feature related to the partition vehicle of the first or the second aspects of the invention, i.e. comprising a number of wheels such as four or more wheels allowing movements in the X-direction, a vehicle body including wall member forming a cross sectional area perpendicular to the X-direction set by the wheels and a seal surrounding an edge of the wall member. Furthermore, the vehicle body may comprise an upright partition oriented perpendicular to the X-direction. At least two of the wheels at each side of the partition vehicle may be driven by a motor such as a DC motor fixed to the vehicle body and/or within the wheels. The wheels may be placed at or near the corners of the vehicle body.

In a sixth aspect, the invention concerns a method for transferring storage containers between a first space and a second space within an automated storage and retrieval system as described in the first aspect.

The method comprises the steps of:
moving the partition vehicle into the second position such that the container transfer space is accessible for the first container handling vehicle;
lifting a storage container stored within the first storage volume using a lifting device constituting part of the first container handling vehicle;
transporting the storage container into the tunnel;
dropping off the storage container within the container transfer space;
moving the partition vehicle into the first position such that the container transfer space is accessible for the container transporting device;
lifting the storage container from the container transfer space;
transporting the storage container to another location within the second space.

Subsequently the method may include
returning the storage container from the second space to the first space. The method may perform the steps mentioned above but in reverse.

In an exemplary method of the sixth aspect, the container transporting device is a second container handling vehicle configured to transport the at least one of the storage containers along the rail system. In this exemplary method, the storage and retrieval system comprises a second storage volume contained within the second space and allowing storage of storage containers in vertical stacks and the transporting of the storage container to another location within the second space is performed along the rail system.

This exemplary method may further comprise the step of placing the storage container onto a stack within the second storage volume.

In addition to solve or at least mitigate the problems described above and to provide solutions for allowing handling of bins within a storage system located in a space having an environment different than the surrounding environment, at least some of the exemplary configurations have the additional advantage:
to provide an an automated storage and retrieval system which allows safe long-term storage of biological species and/or fresh food;
to provide an an automated storage and retrieval system which prevent condensation of electronics within container handling vehicles during transfer of bins between zones;
to provide an an automated storage and retrieval system that significantly reduces the risk of a fire starting within or on the storage system during operation.

### BRIEF DESCRIPTION OF THE DRAWINGS

The following drawings depict embodiments of the present invention by way of example only and are appended to facilitate the understanding of the invention.

FIG. 1 is a perspective view of a prior art automated storage and retrieval system comprising a rail system onto which a plurality of remotely operated container handling vehicles is operating and a storage volume for storing stacks of containers.

FIG. 2 is a perspective view of a prior art remotely operating vehicle having a centrally arranged cavity for carrying containers therein.

FIG. 3 is a perspective view of a prior art remotely operating vehicle having a cantilever for carrying containers underneath.

FIG. 4 is a perspective view of a prior art remotely operating vehicle having an internally arranged cavity for carrying containers therein, wherein the cavity is offset from center relative to the X-direction.

FIG. 5 is a side view of an exemplary automated storage and retrieval system according to the invention, comprising a rail system onto which a plurality of remotely operated container handling vehicles is operating and two storage volumes for storing stacks of containers, wherein the two storage volumes are separated by a wall.

FIG. 6 is a perspective view of container handling vehicles and part of an exemplary container transfer system comprising a wall, a tunnel and a partition vehicle.

FIG. 7 are perspective views of part of the container transfer system in FIG. 6, where FIG. 7A shows the partition vehicle in position outside the tunnel and FIG. 7B shows a detailed view of part of the drive means of the partition vehicle.

FIG. 8 are perspective views of container handling vehicles and part of an exemplary container transfer system, where FIG. 8A and FIG. 8B show container handling vehicles on both sides of the wall.

FIG. 9 is a perspective view of a container handling vehicle and part of an exemplary container transfer system, where the partition vehicle is arranged within the tunnel.

FIG. 10 are perspective views of two container handling vehicles and part of an exemplary container transfer system, where FIG. 10A shows the partition vehicle at an opening of the tunnel towards a first space, FIG. 10B shows a container handling vehicle moved from a second space to a position within the tunnel allowing delivery of a storage container into a container transfer space, FIG. 10C shows the partition vehicle at an opening of the tunnel towards the second space and FIG. 10D shows a container handling vehicle moved from the first space to a position within the tunnel allowing pick-up of a storage container from within the container transfer space.

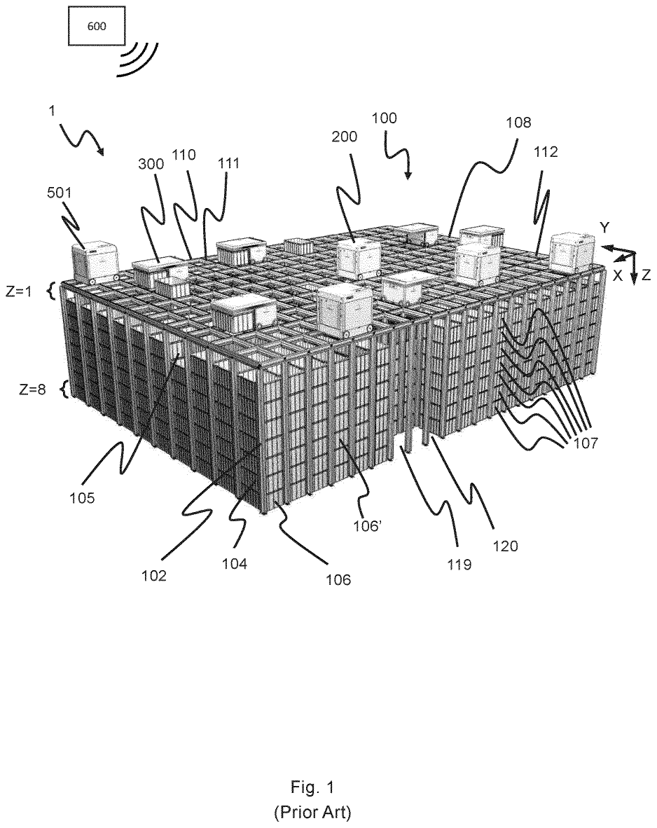

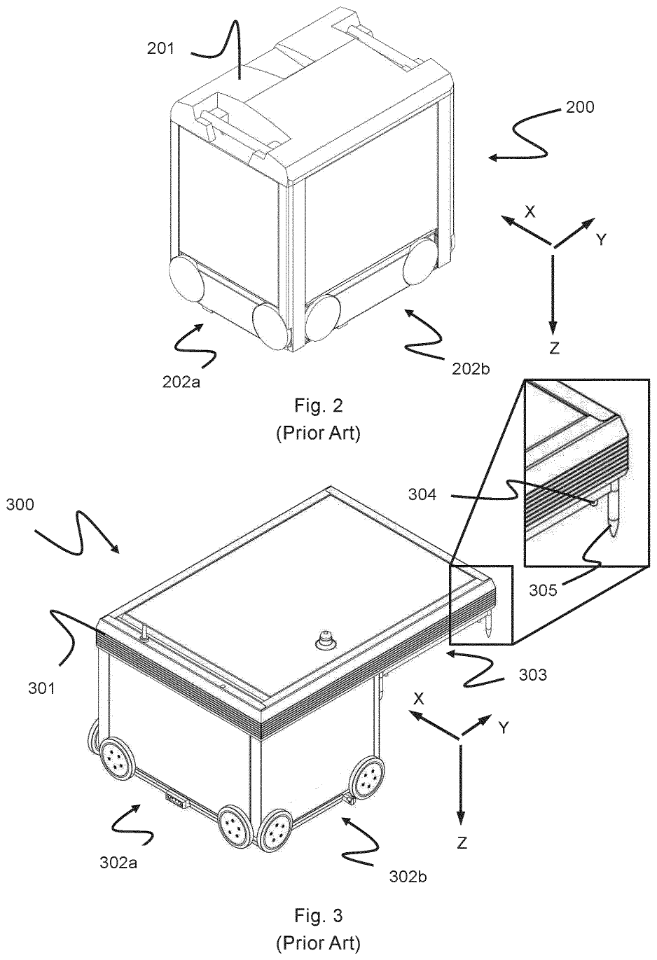

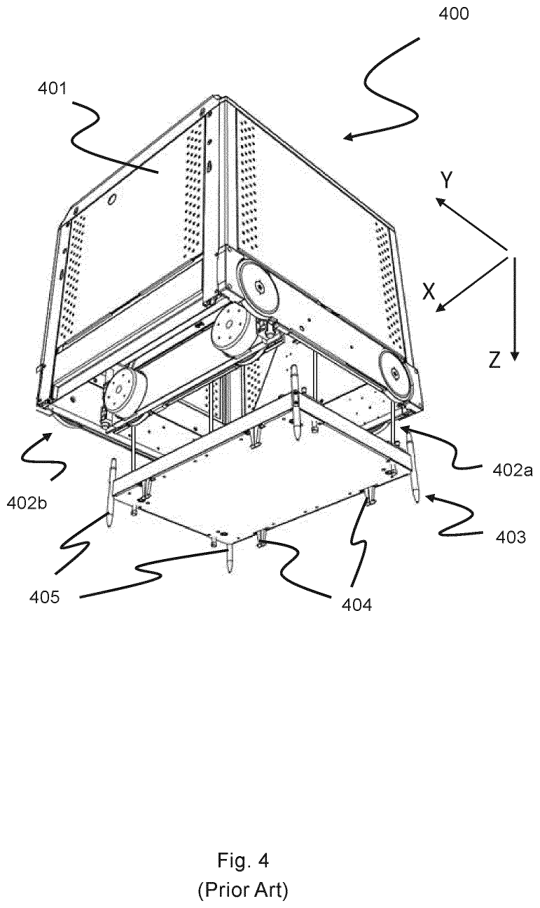

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings. Furthermore, even if some of the features are described in relation to the system, the partition vehicle, the assembly of the tunnel and the partition vehicle or the container transfer system only, it is apparent that they are valid for the related methods as well, and vice versa.

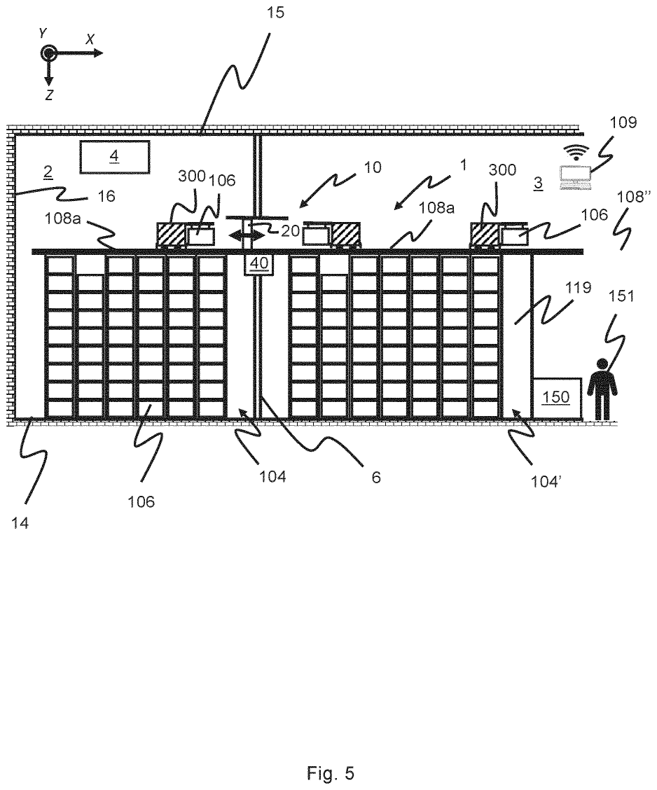

FIG. 5 shows a side view of an automated storage and retrieval system 1 according to the invention. Positive X, Y-and Z-directions are directed from left to right of the drawing, out of the drawing and from top to bottom of the drawing, respectively.

The inventive system 1 is divided into a first space 2 and a second space 3 by a separation wall 6 and a bin transfer space 40 (container transfer space). Both the first space 2 and the second space 3 contain a storage volume 104,104′ with a common floor 14, having bins 106 (storage containers) in vertical stacks 107. A rail system 108 as described in connection with the prior art system of FIG. 1 extends above all three spaces 2,3,40. The part of the system 1 within the second space 3 also includes one or more port columns 119 for drop off or pick up of bins 106 to be transported to/from an access station 150. Further handling of bins 106 may be performed by an operator 151. The bin transfer space 40 is in FIG. 5 shown with a depth corresponding to containing one bin 106. However, the bin transfer space 40 may be configured to accept a stack of bins 107 with a depth deeper than one bin 106, for example, a depth extending some (e.g., two or three bin depths) or even all of the way down to the floor 14.

If the purpose is to maintain the first space 2 at a temperature different from the second space 3, the separation wall 6 may comprise thermal isolating materials, such as polystyrene or fiberglass.

If the purpose is to prevent spread of fire from the first space 2 to the second space (or vice versa), the separation wall 6 may comprise (in addition or alternatively to thermal isolating materials) fireproof material such as fire-resistant glass, concrete, gypsum, stucco and brick

The system 1 also include bin handling vehicles 300 (container handling vehicles) operating on top of the rail system 108 in both the first and the second space 2,3.

The bin transfer space 40 is configured to allow pick-up and drop-off of bins 106 by the bin handling vehicles 300 from both sides of the wall, and is in FIG. 5 arranged beneath the rail system 108, between the first space 2 and the second space 3 and centered along the X axis with respect to the separation wall 6.

In addition to the floor 14, the storage system 1 comprises a ceiling/roof 15, a second vertical wall 16 arranged oriented in the Y-Z plane opposite of the storage volume 104 within the first space 2, and two additional walls oriented in the X-Z plane at the front and back (not shown in FIG. 5), thereby enclosing the first space 2.

One or more throughgoing tunnels 10 are arranged through the wall 6, immediately above the part of the rail system 108 covering the bin transfer space 40. The size of the tunnel(s) 10 is/are sufficiently large to allow bins 106 to be transported between the first space 2 and the second space 3. The hole(s) that need(s) to be made in the wall 6 to fit the bin transfer system(s) should hence be equal or larger than the height of the tunnel(s) 10 and the height of the bin transfer space(s) 40.

In order to allow closure between the two spaces 2,3, a partition vehicle 20 is arranged on the rail system 108 and is configured to move through the tunnel 10 while contacting, or near contacting, inside walls of the tunnel 10.

When the system 1 is used for maintaining an environment within the first space 2 different from the second space 3, for example, an environment having a lower temperature and/or containing a different gas, the enclosed first space 2 may be made fluid-tight, or near fluid-tight, at time periods when the partition vehicle 20 is placed in a closed position within the tunnel 10, for example, at one of the two openings of the tunnel 10, referred to herein as the first and second partition positions.

Hereinafter, fluid-tight means no or insignificant uncontrolled leakage of gaseous substances during closed condition.

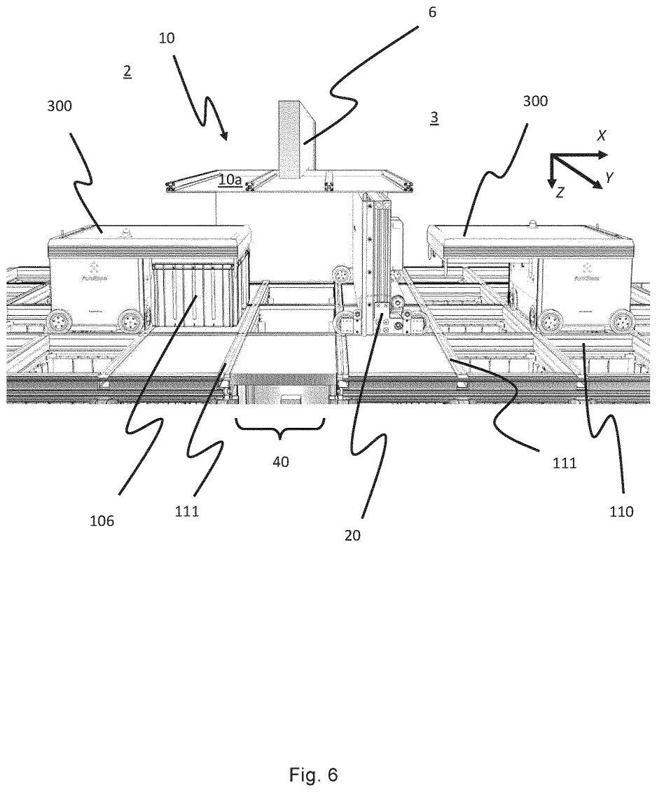

FIG. 6 shows an example of a container transfer system 6,10,11,20 allowing said transfer of bins 106 between the first space 2 and the second space 3. The tunnel 10 comprises a horizontal tunnel roof 10a oriented parallel to the rail system 108 and two vertical side walls 10b oriented along the X direction. Hence, the tunnel 10 forms two openings with cross sectional areas along the Y direction. In FIG. 6, one of the two side walls 10b have been removed to better illustrate the tunnel's inner volume.

In FIG. 6, the partition vehicle 20 has been moved to the opening of the tunnel 10 nearest the second space 3, thereby allowing a bin handling vehicle 300 (a container handling vehicle) operating within the first space 2 to move into a position where the bin handling vehicle 300 may drop off the bin 106 into the centrally arranged bin transfer space 40. Another bin handling vehicle 300 operating within the second space 3 is in position to pick-up the bin 106 after drop-off and movement of the partition vehicle 20 to the opposite opening of the tunnel 10.

In the particular example shown in FIG. 6, the bin transfer space 40 is of a size corresponding to two grid cells defining two grid openings 115 along the Y direction. The width of the tunnel 10 is in this example slightly wider than two grid cells. Note however that the bin transfer space 40 may be of any size in the X and Y directions and may be of any depth (Z direction). If the bin receiving space 40 is extended in the Y direction (width) and/or the X direction (length), the size of the tunnel 10 should be extended accordingly.

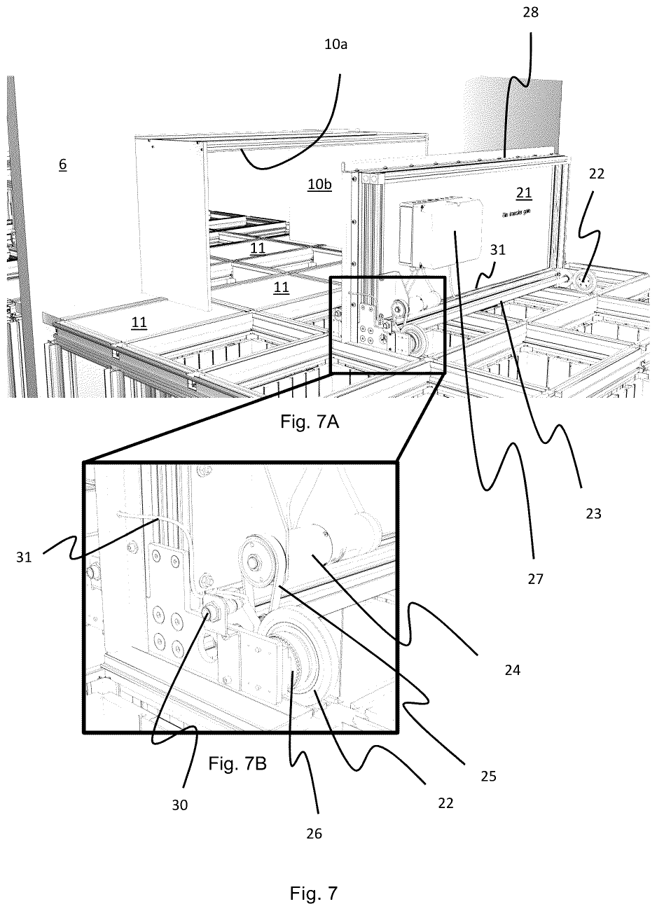

With particular reference to FIG. 7, the partition vehicle 20 comprises drive means 22-26 enabling the vehicle 20 to move along the tunnel 10 in the X direction, a vertical and rectangular plate 21 oriented along the Y direction, a seal 28 arranged along the top edge and the side edges of the plate 21 and a sensor system 30,31 allowing monitoring of the partition vehicle's position relative to the tunnel 10 and/or the rail system 108.

To provide further prevention of leakage of thermal energy and/or gaseous components between the first space 2 and the second space 3 during operation, the seal 28 may also be arranged along the lower edge of the plate 21.

Effective sealing between the partition vehicle 20 and the tunnel 10 (and alternatively also towards the rail system 108) may be achieved using different type of seals 28, for example, rubber seals, brush seals, flaps, rolling seals, air seals, etc,

As illustrated in FIG. 7, when it is required, the partition vehicle 20 may move beyond the tunnel 10, thereby providing direct access through the wall 6. For example, if the tunnel 10 has a cross-sectional area larger than the corresponding cross-sectional area of the bin handling vehicle 300, the latter may move between the first space 2 and the second space 3 when the partition vehicle 20 has been moved sufficiently away from the tunnel openings.

To further lower the risk of thermal leakage and/or gaseous leakage, in particular during transfer of bins 106, the inner volume of the tunnel 10 may include a transfer floor 11 arranged on both sides of the bin transfer space 40 in the form of floor plates arranged within the adjacent grid openings 115.

As for the partition wall 6, the partition vehicle 20, the floor plates 11 and/or the tunnel 10 may comprise thermal isolating materials such as polystyrene, fiberglass or polyurethane foam if the intention of the storage system 1 is to maintain the first space 2 and the second space 3 at different temperatures.

If the intention is fire protection, it is also possible to include fire-proof material into one or more of the space dividing components (partition wall 6, partition vehicle 20, floor plates 11, tunnel 10). Examples of fireproof materials that may be used are fire-resistant glass, concrete, gypsum, stucco and brick.

Still with reference to FIG. 7, the drive means 22-26 of the partition vehicle 20 may comprise
four partition vehicle wheels 22 allowing movements of the partition vehicle 20 along the rail system 108 in the X-direction,
four wheel mounts 26 rotationally connecting the partition vehicle wheels 22 to a framework of the partition vehicle 20,
a motor 24,
a controller 27 in signal communication with the motor 24,
a drive shaft 23 rotationally coupled to at least two of the four partition vehicle wheels 22 and
a transmission belt 25 configured to transmit power from the motor 24 to rotate the drive shaft 23 and thereby to move the partition vehicle 20 the desired length in the X-direction.

The controller 27 may be in wireless signal communication with the control system 109 controlling the bin handling vehicles 300 on the rail system 108.

The sensor system 30,31 typically comprises two position sensors 30 arranged on both sides of the plate 21, allowing monitoring of the positions of the partition vehicle 20 relative to external structures such as the underlying rail system 108 and/or the tunnel 10. The two position sensors 30 are in FIGS. 6 and 7 shown to be in signal communication with each other through a sensor wire 31 and further in signal communication with the controller 27.

When the intention of the system is to maintain a temperature within the first space 2 different from the temperature within the second space 3, for example, that the first space 2 is a chilled space and the second space 3 is an ambient space, the partition vehicle 20 may also comprise temperature sensors 30 on both sides of the plate 21, thereby allowing real-time monitoring of the temperature difference. This again would allow swift detection of undesired temperature equalization through the tunnel 10 during bin transfer, for example, due to a damaged seal 28.

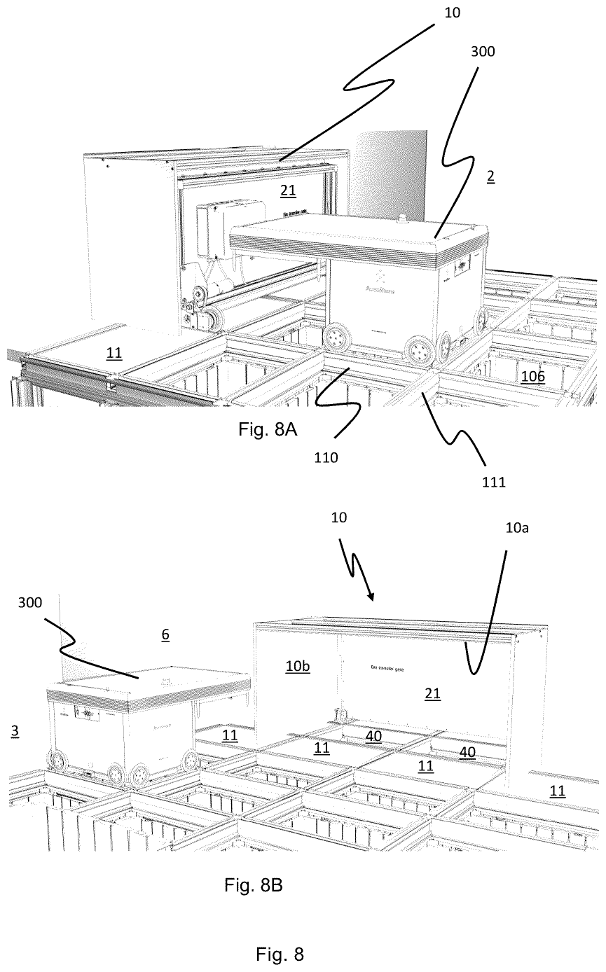

FIG. 8 shows a situation where a bin 106 is going to be transported from the first space 2 to the second space 3 through the tunnel 10 by use of bin handling vehicles 300.

In FIG. 8A, a bin handling vehicle 300 is moving on the rail system 108 towards the tunnel opening within the first space 2 carrying the bin 106 to be transported. The partition vehicle 20 is arranged in this tunnel opening, thereby preventing the bin handling vehicle 300 from access to the bin transfer space 40 located centrally within the tunnel 10 relative to the X-direction.

As is clearly seen in FIG. 8A, the partition vehicle 20 arranged in the tunnel opening forms a fluid-tight closure, or near fluid-tight closure, into the tunnel 10 due to the seal 28 and the floor plates 11.

FIG. 8B shows the situation on the other side of the wall 6, that is in the second space 3, where a bin handling vehicle 300 is moving towards the tunnel opening opposite of the opening shown in FIG. 8A.

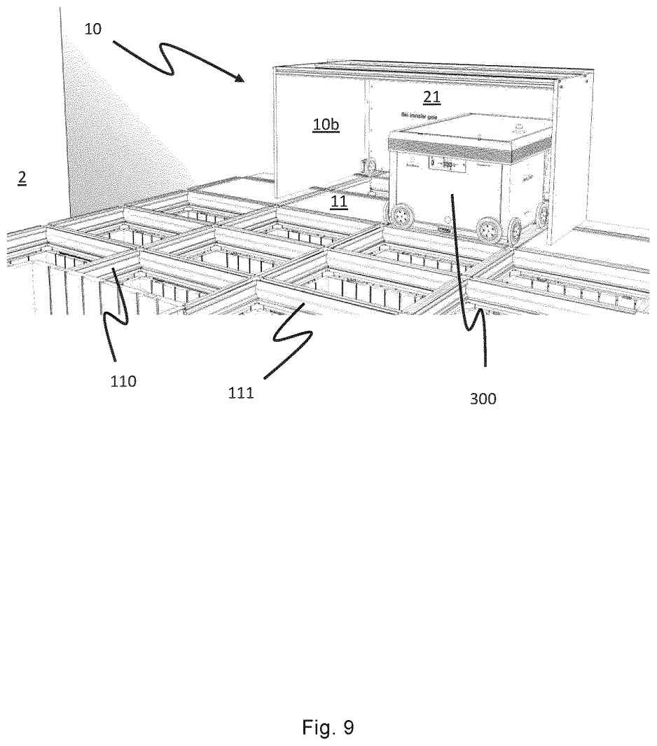

FIG. 9 shows the situation similar to FIG. 8A, but where the partition vehicle 20 has moved to the opposite side of the tunnel 10 and where the bin handling vehicle 300 has moved inside the tunnel 10 such that the bin 106 is aligned with a grid opening 115 above the bin transfer space 40.

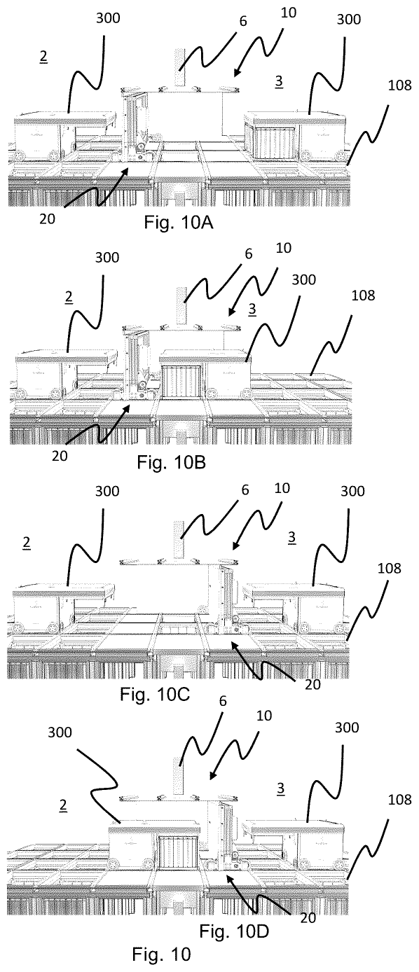

FIGS. 10A-D show an example sequence to transport a bin 106 from the second space 3 (for example, an ambient space at room temperature) to the first space 2 (for example, a chilled space with temperature below 5° C.).
(FIG. 10A) The partition vehicle 20 is moved to the opening of the tunnel 10 within the first space 2.
(FIG. 10B) A bin handling vehicle 300 within the second space 3 transports a bin 106 into the tunnel 106 such that the bin 106 is directly above a grid opening 115 providing bin access to the bin transfer space 40 arranged beneath the rail system 108.
(FIG. 10C) The bin 106 is dropped into the bin transfer space 40 through the grid opening 115, the bin handling vehicle 300 is moved out of the tunnel 10 and the partition vehicle 20 is moved to the opening of the tunnel 10 within the second space 3.
(FIG. 10D) A bin handling vehicle 300 within the first space 2 moves into the tunnel such that its lifting device 303 is vertically aligned with the grid opening 115 and the bin 106 is lifted above the rail system 108 by use of the lifting device 303.

In order to at least reduce the risk of fire within the first space 2, the system may be equipped with a gas regulating device (not shown). The gas regulating device may comprise a gas container located outside the first space 2, a gas inlet going into the first space 2 and a gas tube in fluid communication between the gas container and the gas inlet. With this arrangement, gas is allowed to flow between the gas container and the first space 2.

The gas container may comprise means for reducing a percentage of a gas element in a gas mixture, such as O₂ gas in air. Such means are known in the art and will thus not be explained further herein.

In dry air, the concentration of the flammable gas oxygen is about 21 %. If the oxygen concentration is lowered to 16 % or below, the risk of fire is significantly reduced. In air, a fire may potentially occur in theory, for example, due to sparks from the movements of the bin handling vehicles 300 and/or sparks from the charging stations (not shown) for charging the batteries within the vehicles 300 and/or combustion of contents within bins 106 and/or accidental heating such as may be caused by sunlight hitting flammable material within the storage system 1.

The gas-tight separation between the first space 2 and the second space 3 ensures that the bin handling vehicles 300 may store and fetch bins 106 located within an oxygen reduced atmosphere that has a reduced or insignificant risk of fire, but which may represent a health risk for humans, and to receive and deliver bins 106 to a workspace in which humans may safely work.

Another example of a range of use for a storage system 1 allowing control of gas concentration is storage of fresh food. Prior art tests have shown that that fruits such as apples may be best long-term stored in an atmosphere comprising 1 % O₂ and 1-2.5 % CO₂. The O₂ gas may be replaced with N₂ gas.

A storage system 1 having both a cooling facility for cooling the first space 2 to temperatures below 10° C. and a gas regulating device, may create near ideal condition for storage of fresh food.

This fresh food configuration of the storage facility may be supplemented by a fire extinguishing device to decrease fire hazards.

In addition to the advantages mentioned above, the inventive storage system 1 facilitate installation and maintenance since all sensor technology 30,31 and drive means 22-26 may be placed on the easy removable partition vehicle 20 instead of the fixed tunnel 10, bin transfer space 40 or wall 6 (which are also possible solutions). The controller 27 of the partition vehicle 20 can be connected to the control system 109 by WIFI or cable network.

To further reduce the complexity, the partition vehicle 20 may alternatively be equipped with a motor 24 having an internal motor controller. A programmable logic controller (PLC) sends instructions to the motor 24 for direction and speed. The sensor system 30,31 sends instructions to the motor 24 to stop the partition vehicle 20 when it arrives to an end position (for example, an opening of the tunnel 10).

A mechanical stopper may be provided at one or both tunnel openings to prevent the partition vehicle 20 to move out of the tunnel 10.

In the preceding description, various aspects of the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMERALS/LETTERS

1 Automated storage and retrieval system
2 First space/chilled space
3 Second space/ambient space
4 Cooling system/refrigerator
6 Separation wall
10 Tunnel
10a Tunnel roof
10b Tunnel side wall
11 Transfer floor of container transfer space 40/floor plates
14 Floor
15 Roof
16 External wall
20 Partition vehicle
21 Plate
22 Partition vehicle wheels
23 Drive shaft
24 Motor
25 Transmission belt
26 Wheel mount
27 Controller
28 Seal/rubber frame
30 Position sensor
31 Sensor wire
40 Container transfer space/bin transfer space
100 Framework structure
102 Upright members within storage volume
103 Horizontal members within storage volume
104 First storage volume
104′ Second storage volume
105 Storage column
106 Container/storage container/bin
106′ Particular position of a container/target container/target bin
106″ Vacant storage space for a container/bin
107 Stack
108 Rail system
109 Control system
110 Parallel rails in first direction (X)
111 Parallel rail in second direction (Y)
112 Grid opening
119 First port column/drop-off column
120 Second port column/pick-up column
150 Access station
151 Operator
200 Prior art container handling device/remotely operated vehicle with central cavity
201 Handling device body/Vehicle body
202a Drive means in first direction (X)
202b Drive means in second direction (Y)
300 Prior art container handling vehicle/remotely operated vehicle with cantilever/bin handling vehicle
301 Handling device body/Vehicle body
302a Drive means/wheel arrangement, first direction (X)
303b Drive means/wheel arrangement, second direction (Y)
303 Lifting device
304 Gripper element
305 Guiding pin
400 Prior art container handling device/remotely operated vehicle with offset cavity
401 Handling device body/Vehicle body
402a Drive means/wheel arrangement, first direction (X)
402b Drive means/wheel arrangement, second direction (Y)
403 Lifting device
404 Gripper element
405 Guiding pin
X First direction
Y Second direction
Z Third direction

1.-15. (canceled)

16. An automated storage and retrieval system comprising:
a first storage volume allowing storage of storage containers in vertical stacks,
a rail system arranged above where the storage containers in vertical stacks would be stored;
a wall, wherein the wall separates a first space of the automated storage and retrieval system containing the first storage volume from a second space of the automated storage and retrieval system, the rail system continuing in the second space,
a tunnel extending through the wall at a level of the rail system, wherein the tunnel is configured to allow transport of storage containers between the first space and the second space, and
a partition vehicle arranged within the tunnel, wherein the partition vehicle is configured to move between a first position within the first space and a second position within the second space of the automated storage and retrieval system.

17. The automated storage and retrieval system according to claim 16, wherein the first space is enclosed in order to avoid surrounding gas to enter in an uncontrolled manner.

18. The automated storage and retrieval system according to claim 16, further comprising a container transfer space extending from a side of the first storage volume and configured to hold at least one of the storage containers.

19. The automated storage and retrieval system according to claim 18, further comprising:
a first container handling vehicle configured to lift a storage container from the first storage volume and to transport the storage container along the rail system to the container transfer space; and
a container transporting device configured to lift the storage container from the container transfer space and to transport the storage container to another location, optionally wherein the container transporting device is a second container handling vehicle configured to transport a storage container from the container transfer space along the rail system.

20. The automated storage and retrieval system according to claim 18, further comprising:
a second storage volume contained within the second space and allowing storage of storage containers in vertical stacks, wherein the container transfer space extends through the wall between the first storage volume and the second storage volume.

21. The automated storage and retrieval system according to claim 18, wherein the container transfer space is arranged below the rail system.

22. The automated storage and retrieval system according to claim 18, wherein the container transfer space is positioned such that a center plane of the wall intersects a center of the container transfer space.

23. The automated storage and retrieval system according to claim 16, wherein the automated storage and retrieval system comprises a cooling unit configured to provide a cooler first temperature within the first space than a second temperature within the second space and wherein the wall is provided with thermal insulation to reduce thermal conductivity between the first and second spaces.

24. The automated storage and retrieval system according to claim 16, wherein the partition vehicle comprises drive means to drive the partition vehicle between the first and second positions.

25. The automated storage and retrieval system according to claim 24, wherein the partition vehicle comprises a sensor configured to register a position of the partition vehicle relative to the tunnel, wherein the sensor is in signal communication with the drive means.

26. The automated storage and retrieval system according to claim 16, wherein the partition vehicle comprises wheels configured to move along a first set of rails.

27. The automated storage and retrieval system according to claim 16, wherein a partition width of the partition vehicle equals n times the width of a grid cell, wherein n is a positive integer.

28. The automated storage and retrieval system according to claim 16, wherein the partition vehicle comprises:
a member oriented in parallel with a center plane of the wall; and
a seal surrounding an edge of the member, wherein the seal is arranged to contact inside walls of the tunnel and the rail system when the partition vehicle is moving between the first position and the second position.

29. The automated storage and retrieval system according to claim 16, wherein a storage facility comprises a floor extending along the rail system at least across an opening of the tunnel in at least the first position or the second position.

30. A method for transferring storage containers between a first space and a second space within an automated storage and retrieval system according to claim 19, wherein the method comprises:
moving the partition vehicle into the second space such that the container transfer space is accessible for the first container handling vehicle;
lifting a storage container stored within the first storage volume using a lifting device constituting part of the first container handling vehicle;
transporting the storage container into the tunnel;
dropping off the storage container within the container transfer space;
moving the partition vehicle into the first space such that the container transfer space is accessible for the container transporting device;
lifting the storage container from the container transfer space; and
transporting the storage container to another location within the second space.

31. The method according to claim 30,
wherein the container transporting device is a second container handling vehicle configured to transport the at least one of the storage containers along the rail system;
wherein the storage and retrieval system further comprises a second storage volume contained within the second space and allowing storage of storage containers in vertical stacks;
wherein the transporting of the storage container to another location within the second space is performed along the rail system; and
wherein the method further comprises placing the storage container onto a stack within the second storage volume.
